(19) United States
(12) Patent Application Publication
(10) Pub. No.: US 2012/0039725 A1
(43) Pub. Date: Feb. 16, 2012

(54) METHOD, SYSTEM AND APPARATUS FOR POWERING A COMPRESSOR VIA A DAM

(76) Inventor: Rene Carlos, College Park, MD (US)

(21) Appl. No.: 12/858,311

(22) Filed: Aug. 17, 2010

Related U.S. Application Data
(63) Continuation-in-part of application No. 12/854,707, filed on Aug. 11, 2010.

(51) Int. Cl. F04B 17/00; F02B 63/04

(52) U.S. Cl. 417/53; 290/1 R; 417/334

(57) ABSTRACT

A method, system and apparatus for powering a compressor are provided. Flowing water is supplied from a dam to a power generation mechanism via a compressor water channel. The flowing water is used to drive the power generation mechanism in order to generate power. One or more compressor stages of a heat engine are then driven using power generated by the power generation mechanism. The flowing water in the compressor water channel is driven at least in part by gravity due to head of the dam.

### CROSS REFERENCE TO RELATED APPLICATIONS

This application claims priority of U.S. patent application Ser. No. 12/854,707, filed Aug. 11, 2010. The subject matter of this earlier filed application is hereby incorporated by reference in its entirety.

### BACKGROUND

1. Field

The present invention relates to a method, system and apparatus for powering a compressor. More specifically, the method, system and apparatus use potential energy from the head of a dam to power one or more stages of a compressor.

2. Description of the Related Art

In power generation systems, gas turbines are known that extract energy from a combustible fuel. For instance, a gas turbine generally has an upstream multi-stage compressor that compresses air flowing into the engine, a combustion chamber where fuel (typically gas) is ignited and combusted with the compressed air, and a turbine that harnesses the energy from the flow of the combustion gases. The combusted gas is then expelled from the rear of the engine. The rotating turbine drives an electric generator that converts mechanical energy into electrical energy, and thus creates electricity.

### SUMMARY

Certain embodiments of the present invention may provide solutions to the problems and needs in the art that have not yet been fully solved by currently available gas turbine technologies. For example, certain embodiments of the present invention provide a method and system that uses head of a dam to power one or more compressor stages of a Brayton cycle heat engine, such as a gas turbine. This uses less external power to drive the Brayton cycle heat engine and delivers on-demand power more effectively and efficiently than typical Brayton cycle heat engines.

In one embodiment of the present invention, a system includes a power generation mechanism configured to be driven by flowing water. The system also includes a compressor water channel configured to supply flowing water from a dam to the power generation mechanism. The system further includes a heat engine including a compressor with one or more compressor stages. The power generation mechanism is configured to drive the one or more compressor stages. The flowing water in the compressor water channel is driven at least in part by gravity due to head of the dam.

In another embodiment of the present invention, an apparatus includes one or more compressor stages of a heat engine having one or more external blades. The apparatus also includes one or more compressor stage water conduits surrounding the one or more compressor stages. The apparatus further includes one or more compressor stage entry inlets configured to supply flowing water from a dam to the one or more compressor stage water conduits. The flowing water drives the external blades of the one or more compressor stages, causing the one or more compressor stages to rotate. The flowing water is driven at least in part by gravity due to head of the dam.

In yet another embodiment of the present invention, a method includes supplying flowing water from a dam to a power generation mechanism via a compressor water channel. The method also includes driving the power generation mechanism using the flowing water to generate power. The method further includes driving one or more compressor stages of a heat engine using power generated by the power generation mechanism. The flowing water in the compressor water channel is driven at least in part by gravity due to head of the dam.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is a side view of a dam system combining gas turbine power generation and hydroelectric power generation, according to some embodiments of the present invention.

FIG. 2 is a side view of a direct mechanical water drive powering the low pressure section of a gas turbine in a dam, according to an embodiment of the present invention.

FIG. 3 is a side view of a direct electrical water drive powering the low pressure section of a gas turbine in a dam, according to an embodiment of the present invention.

FIG. 4 is a side view of a water turbine and generator powering the low pressure section of a gas turbine in a dam, according to an embodiment of the present invention.

FIG. 5 is a side view of a system where the low pressure compressor section of a gas turbine in a dam is powered by water running through external blades on the compressor stages, according to an embodiment of the present invention.

FIG. 6 is a side view of the water feed mechanism for three fan stages of the compressor, according to an embodiment of the present invention.

FIG. 7 is a front view of a compressor fan stage that is driven by water flowing through external blades, according to an embodiment of the present invention.

FIG. 8 illustrates a flow diagram of a method for powering one or more stages of a compressor, according to an embodiment of the present invention.

FIG. 9 illustrates a flow diagram of another method for powering one or more stages of a compressor, according to an embodiment of the present invention.

FIG. 10 is a side view of a gas turbine, according to an embodiment of the present invention.

FIG. 11 is a side view of a section of a gas turbine with non-nesting spools, according to an embodiment of the present invention.

### DETAILED DESCRIPTION

It will be readily understood that the components of various embodiments of the present invention, as generally described and illustrated in the figures herein, may be arranged and designed in a wide variety of different configurations. Thus, the following more detailed description of the embodiments of a system and method of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

Existing industrial gas turbine power generation systems have certain disadvantages. For instance, a drawback to gas turbine power generation systems is that on an industrial scale, it generally takes a significant amount of time and energy to spin up the compressor. This reduces the desirability of, and ability to, generate on-demand power. For instance, it may be desirable to activate certain power systems to generate on-demand power in order to satisfy a peak load on the system. Such a peak load typically occurs around 3:00 pm, particularly during summer months when much of the power demand for air conditioning occurs.

Accordingly, it may be beneficial to power one or more compressor stages of the gas turbine via another source. One such source may be water pressure. However, the pressure of municipal water supplies is typically too weak to power one or more stages of a compressor. Further, pressurizing municipal water by mechanical means would consume energy, and perhaps require more energy than is saved by powering one or more stages of the compressor.

Some embodiments of the present invention are able to overcome these disadvantages by using the far greater potential energy from the head of a dam to drive one or more stages of a compressor. Head may be defined as the difference in height between the water's source and water outflow. Some of the power generation mechanisms that may harness the potential energy from the dam include, but are not limited to, a direct mechanical water drive, a direct electrical water drive, a turbine/generator combination, or by external blades on the compressor stage(s). The number of compressor stages that are powered by embodiments of the present invention is a matter of design choice. By powering one or more stages of the compressor, a heat engine that includes the compressor may be powered up more quickly to begin generating power.

Driving one or more compressor stages of the heat engine reduces consumption of any fuel that may be used, and produces less pollution than conventional systems. Further, due to the powering of one or more stages of the compressor with dam head, the power generated by the heat engine is highly dispatchable (time-variable under active command), which can be a valuable secondary attribute that not all generation types possess. The commercial potential of such a system is high. Output power is in high demand, especially if dispatchable.

A heat engine takes advantage of heat energy to perform mechanical work. The heat engine may be any form of heat engine that is capable of expelling high velocity exhaust and generates heat from a heat source. One example of a heat engine is a Brayton cycle heat engine. A Brayton cycle heat engine may be an internal combustion engine such as a gas turbine engine or a piston engine, or an external combustion engine such as a steam engine. The engine may take any desired form and is not limited by this disclosure in any way. The heat source of the heat engine may be provided by various fuels in some embodiments. For instance, some embodiments may use gases (such as natural gas), liquids (such as petroleum fuels), sufficiently-pulverized coal, biomass, slurries, suspensions, radioisotopes, solar absorbers, geothermal transfer fluids, or any other fuel suitable for driving a heat engine. Due to an advanced pipeline infrastructure at least in the United States, natural gas may be more economical and/or cleaner than many of the other fuel alternatives for U.S. implementations at many existing or potential dam sites.

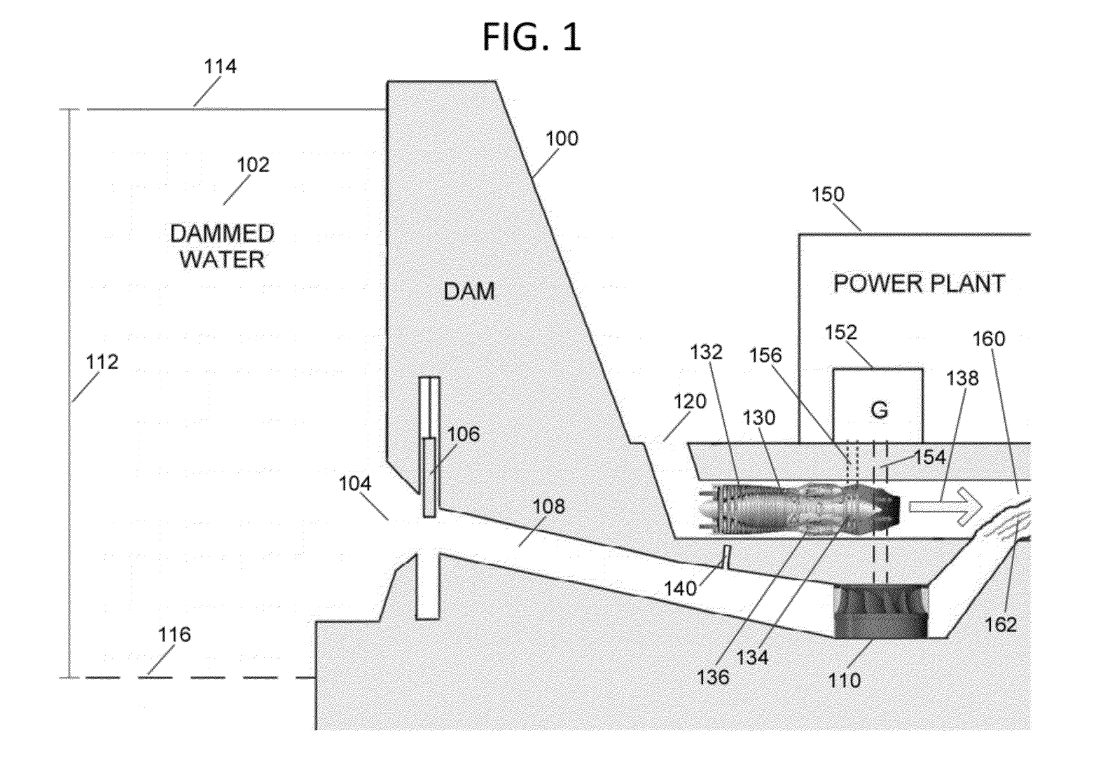

FIG. 1 is a side view of a system combining gas power generation and hydroelectric power generation, according to some embodiments of the present invention. The system depicted here uses exhaust gases from a gas turbine 130 to pull water and generate lower pressure in an exit channel 160, causing the system to behave as though head 112 were higher than it mechanically is. However, some embodiments of the present invention do not take advantage of this synergy and have a gas turbine that does not interact with the water channel. Further, while often advantageous, it is not necessary for a water turbine to be present at all in some embodiments, and dam head may be used for the purpose of driving one or more stages of a compressor of a gas turbine.

The depicted system includes a dam 100 holding back dammed water 102. Water enters dam 100 via a water intake 104 and the flow of the water is controlled by control gate 106. Control gate 106 may be raised or lowered to increase, decrease, or completely restrict water flow to a penstock 108. While penstock 108 is depicted as a water channel here, a pipe, a conduit, or any other suitable water channel or water piping mechanism may be used. After passing control gate 106, the water enters penstock 108 that supplies the water to a water turbine 110. Dammed water 102 has a certain head 112, which is the difference in height between the level of water 114 before the dam 100 and the level of water 116 after the dam 100 (i.e., water that has passed through the dam and is now downstream in the river). However, in some embodiments, the difference in height may be anywhere and not necessarily near the top of the dam.

The system also includes an air intake 120 that supplies air to gas turbine 130. While gas turbine 130 is shown in this embodiment, any suitable heat engine may be used. In this embodiment, compressor water channel 140 provides water that may power one or more stages of a compressor 132 of gas turbine 130 via a power generation mechanism including, but are not limited to, a direct mechanical water drive, a direct electrical water drive, a turbine/generator combination, or by external blades on the compressor stage(s) (not shown). The stages of compressor 132 that are driven by water from compressor water channel 140 may include fewer than all of the stages of the compressor. Further, in this and other embodiments, compressor stages in multiple compressor sections, such as a low pressure compressor section and a high pressure compressor section, may be driven by water from compressor water channel 140. The direct drive shaft uses gravity-driven potential energy from head 112 of dammed water 102 and is driven by water running through compressor water channel 140. Keeping one or more stages of compressor 132 running may be advantageous over existing heat engine systems since compressor 132 can be spun up to generate power more quickly, and with less energy cost, than a typical gas turbine. This may allow gas turbine 130 to generate on-demand power more quickly, efficiently and effectively than existing gas turbines.

In some other embodiments, in lieu of a direct drive shaft, water from compressor water channel 140 runs through a second water turbine that powers another generator. In yet other embodiments, water from compressor water channel 140 may drive external blades that rotate one or more stages of the compressor 132.

A power plant 150 houses a generator complex 152 that generates power for the system. Generator complex 152 may include a single generator or multiple generators. Water turbine 110 and gas turbine 130 are operably connected to generator complex 152 via shafts 154 and 156, respectively. Shafts 154 and 156 may drive the same generator or different generators, depending on the desired implementation. The rotation of water turbine 110 and gas turbine 130 rotates shafts 154 and 156, respectively. In some embodiments, as shafts 154 and 156 turn, a series of magnets inside generator complex 152 also turn. The magnets in such generators generally rotate past copper coils, producing current by generating moving electrons. However, some users may simply accept shaft work in other embodiments. In this embodiment, it is possible to operate water turbine 110 alone, gas turbine 130 alone, or both, at any given time to achieve the desired power output. To further facilitate this selective operation, a gate mechanism (not shown) may be included in some embodiments to prevent water spray from water entering exit channel 160 from heading up exit channel 160 towards gas turbine 130 when gas turbine 130 is not operating.

Exhaust gases 138 from gas turbine 130 accelerate water 162 in exit channel 160 that has passed through water turbine 110. Accelerating water 162 in this fashion takes advantage of the Bernoulli principle and the Coand\check{a} effect to draw water into water intake 104 and through penstock 108 with greater pressure. The Bernoulli principle states that an increase in speed of a fluid occurs simultaneously with a decrease in pressure. The Coand\check{a} effect is the tendency of a rapidly moving fluid jet to be attracted to a nearby surface. In the context of these principles, a “fluid” may be a gas such as air.

The Bernoulli principle and the Coand\check{a} effect cause exhaust gases 138 to pull water 162, decreasing pressure in the exit channel exit channel 160 and increasing a flow of water 162. Further, there is some entrainment of the water stream due to viscous forces. This lower pressure environment in exit channel 160 causes the system to behave as though head 112 of dammed water 102 is greater than it mechanically is. Specifically, the system behaves as though the exit for the water is lower than it mechanically is.

Also, the interaction between hot exhaust gases and water flowing in the exit channel generates steam. In some embodiments, the steam can be recovered for various purposes. For instance, the steam may be harnessed to drive one or more stages of compressor 132 in some embodiments.

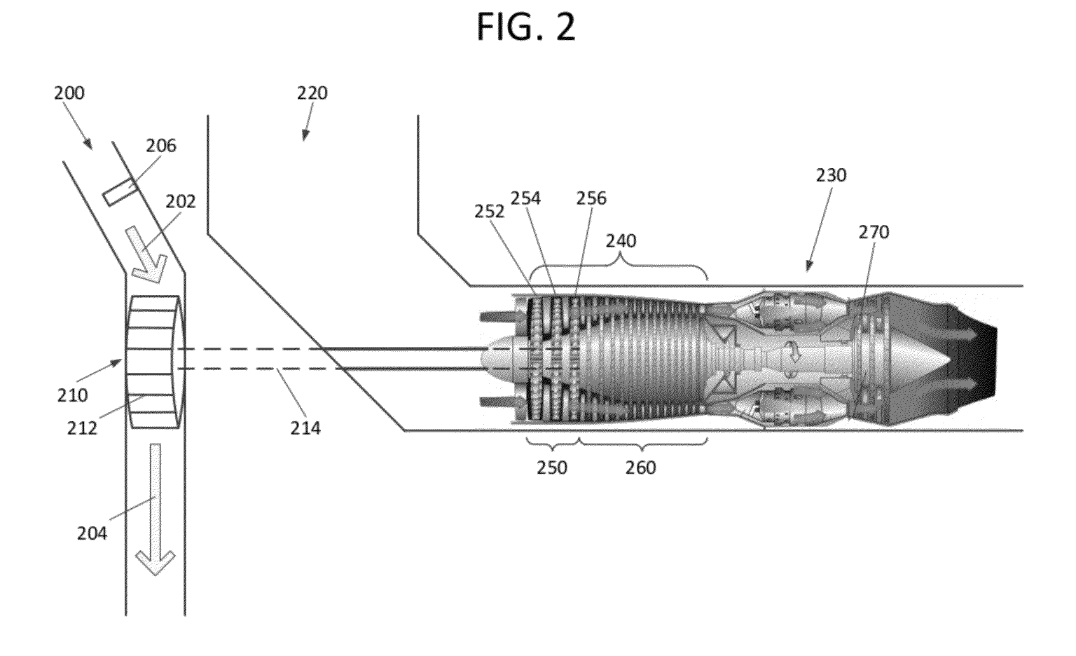

FIG. 2 is a side view of a direct mechanical water drive 210 powering a low pressure section 250 of a gas turbine 230 in a dam, according to an embodiment of the present invention. While a compressor having axial (“fan”) stages is depicted in the figures of the present application, some embodiments of the present invention use compressor types that do not have fan stages, and the compressor type that may be used is not limited in any way. For instance, in some embodiments, a centrifugal, or radial, compressor is used. Among other things, stages of such compressors may use, for example, centrifugal or piston pumps or blowers to generate compression. Further, a combination of different compressor types may be used for different stages of the compressor.

In some embodiments, the system depicted in FIG. 2 may be present in the system depicted in FIG. 1. Gas turbine 230 has a compressor 240 for compressing air that enters through air intake 220. Compressor 240 has a low pressure section 250 and a high pressure section 260, each including multiple fan stages. In this embodiment, low pressure section 250 includes three fan stages 252, 254 and 256.

Water from a dam enters compressor water channel 200 and flows 202 towards direct mechanical water drive 210. The water is driven by gravity due to head of the dam. Direct mechanical water drive 210 has fins or blades 212 that harness the flow of water 202 to rotate direct mechanical water drive 210. After passing through direct mechanical water drive 210, water flows 204 past direct mechanical water drive 210 and on down compressor water channel 200. In some embodiments (not shown), at least part of the water may then be used for injection into warmer stages of compressor 240 and/or into, around, and/or inside gas turbine 230. In some embodiments, water may be misted into a flow of exhaust gases leaving gas turbine 230 to reduce noise.

Direct mechanical water drive 210 is operably connected to one end of a shaft 214 that rotates with the rotation of direct mechanical water drive 210. At the other end, shaft 214 is operably connected to fan stages 252, 254 and 256 of low pressure compressor stages 250, and/or connected to a spool (not shown) that may join low pressure compressor section 250 to turbine 270. However, a turbine is not connected to the spool in some embodiments. Gearing mechanisms (not shown) may be present so fan stages 252, 254 and 256 rotate at different speeds, if desired by the specific architecture of gas turbine 230. However, in many embodiments, fan stages 252, 254 and 256 rotate at the same speed since they are connected to the same spool. Thus, gravity-driven water flowing through direct mechanical water drive 210 drives fan stages 252, 254 and 256 of low pressure compressor section 250.

In some embodiments, a gate mechanism 206 may be present to regulate the flow 202 of water that drives direct mechanical water drive 210. In some embodiments, a valve or any other suitable flow metering mechanism may be used as a gate mechanism. Gate mechanism 206 is capable of restricting, or completely shutting off, the flow of water through compressor water channel 200. In addition to, or in lieu of, gate mechanism 206, a braking mechanism (also not shown) may be included that serves to slow the rotation of direct mechanical water drive 210. The operation of gate mechanism 206 and/or the braking mechanism may be controlled remotely by an electronic controller. In this manner, the speed of rotation of fan stages 252, 254 and 256 of low pressure compressor section 250 can be regulated.

While a shaft is used as a power transfer mechanism in this embodiment, any suitable mechanical means may be used as a power transfer mechanism. For instance, power may be transferred via direct gear teeth, intermediary gearing, or a hydraulic drive that uses a fluid. Further, various combinations of shafts, gearings, and hydraulic mechanisms may be used.

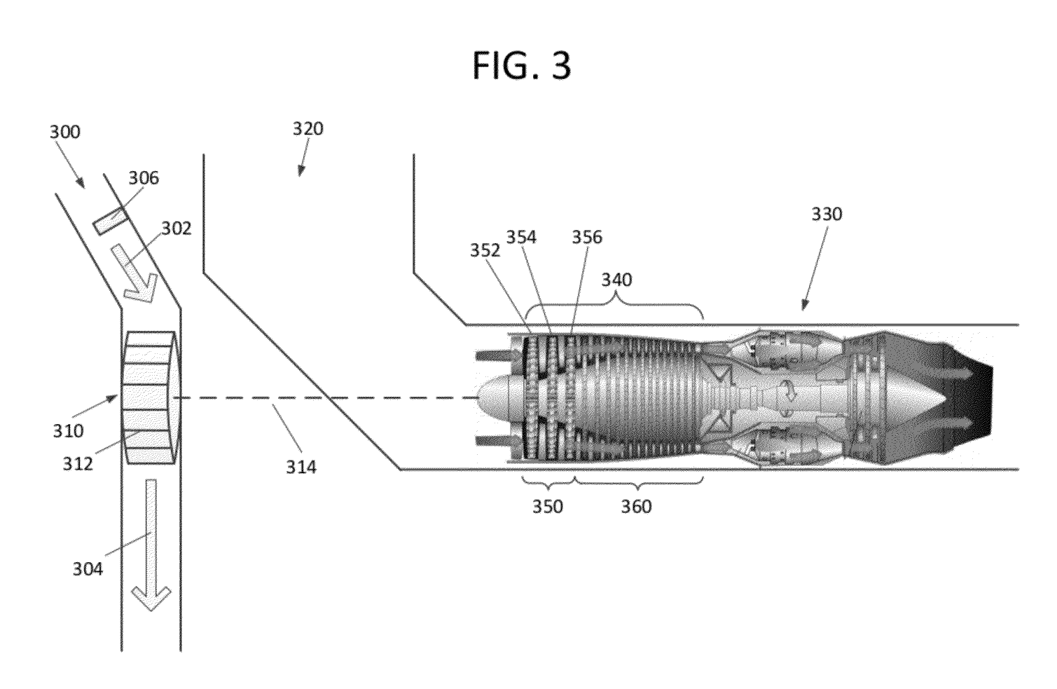

FIG. 3 is a side view of a direct electrical water drive 310 powering a low pressure section 350 of a gas turbine 330 in a dam, according to an embodiment of the present invention. In some embodiments, the system depicted in FIG. 3 may be present in the system depicted in FIG. 1. Gas turbine 330 has a compressor 340 for compressing air that enters through air intake 320. Compressor 340 has a low pressure section 350 and a high pressure section 360, each including multiple fan stages. In this embodiment, low pressure section 350 includes three fan stages 352, 354 and 356.

Water from a dam enters compressor water channel 300 and flows 302 towards direct electrical water drive 310. The water is driven by gravity due to head of the dam. Direct electrical water drive 310 has fins or blades 312 that harness the flow of water 302 to rotate direct electrical water drive 310. After passing through direct mechanical water drive 310, water flows 304 past direct electrical water drive 310 and on down compressor water channel 300. In some embodiments (not shown), at least part of the water may then be used for injection into warmer stages of compressor 340 and/or into, around, and/or inside gas turbine 330. In some embodiments, water may be misted into a flow of exhaust gases leaving gas turbine 330 to reduce noise.

The rotation of direct electrical water drive 310 generates electrical current. Direct electrical water drive 310 is operably connected to a power cable 314 that transmits the electrical current generated by direct electrical water drive 310. Power cable 314 is also operably connected to gas turbine 330 and delivers power thereto. Gas turbine 330 uses the power from power cable 314 to run fan stages 352, 354 and 356 of low pressure compressor section 350. The rotation speed of fan stages 352, 354 and 356 may be controlled by an electronic controller. Thus, gravity-driven water flowing through direct electrical water drive 310 provides power that drives fan stages 352, 354 and 356 of low pressure compressor section 350. Naturally, in embodiments where some or all of the stages are not fan stages, the power may be used to drive another suitable mechanism for such stages, such as centrifugal or piston pumps or blowers.

In some embodiments, a gate mechanism 306 may be present to regulate the flow 302 of water that drives direct electrical water drive 310. Gate mechanism 306 is capable of restricting, or completely shutting off, the flow of water through compressor water channel 300. Gate mechanism 306 may be used to regulate the amount of electricity generated by direct electrical water drive 310. The operation of gate mechanism 306 can also be controlled by an electronic controller. However, rather than regulating the electricity, some embodiments may harness extra electricity for other purposes, such as providing some power to the dam.

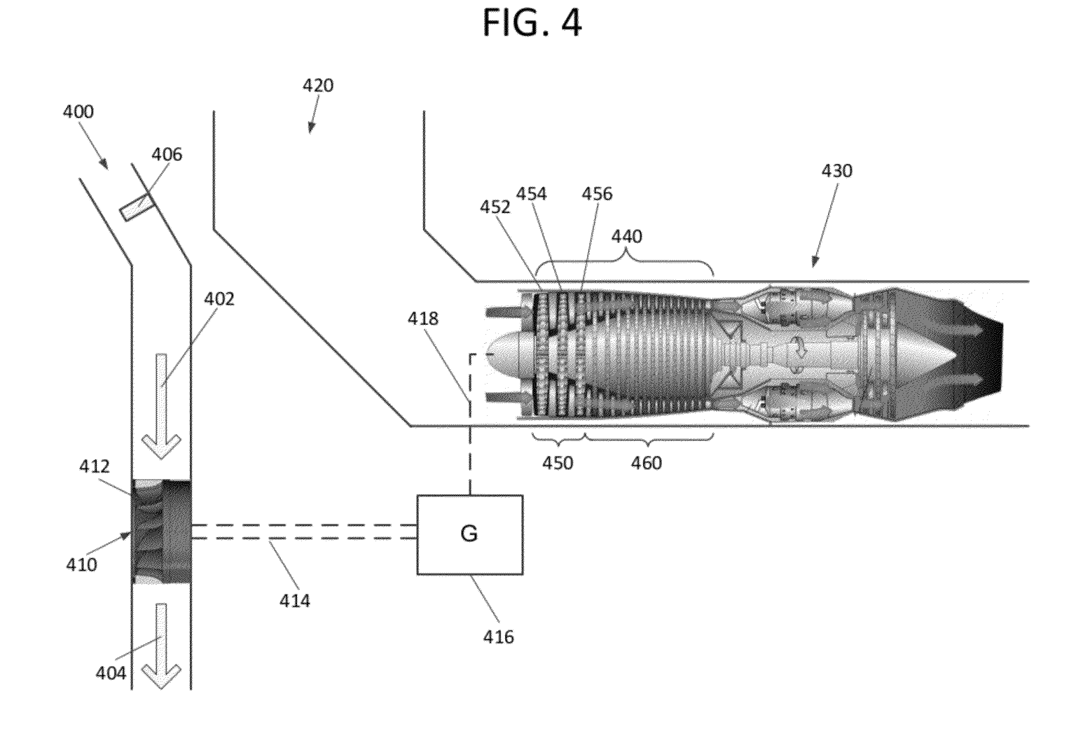

FIG. 4 is a side view of a water turbine 410 and generator 414 for powering a low pressure section 450 of a gas turbine 430 in a dam, according to an embodiment of the present invention. In some embodiments, the system depicted in FIG. 4 may be present in the system depicted in FIG. 1. Gas turbine 430 has a compressor 440 for compressing air that enters through air intake 420. Compressor 440 has a low pressure section 450 and a high pressure section 460, each including multiple fan stages. In this embodiment, low pressure section 450 includes three fan stages 452, 454 and 456.

Water from a dam enters compressor water channel 400 and flows 402 towards water turbine 410. The water is driven by gravity due to head of the dam. Water turbine 410 has fins or blades 412 that harness the flow of water 402 to rotate water turbine 410. After passing through water turbine 410, water flows 404 past water turbine 410 and on down compressor water channel 400. In some embodiments (not shown), at least part of the water may then be used for injection into warmer stages of compressor 440 and/or into, around, and/or inside gas turbine 430. In some embodiments, water may be misted into a flow of exhaust gases leaving gas turbine 430 to reduce noise.

The rotation of water turbine 410 rotates a shaft 414 that is operably connected to both water turbine 410 and generator 416. As shaft 414 turns, a series of magnets inside generator 416 also turn. The magnets in such generators generally rotate past copper coils, producing current by generating moving electrons. A power cable 418, which is operably connected to both generator 416 and gas turbine 430, transmits the generated power from generator 416 to gas turbine 430. Gas turbine 430 uses the power from power cable 418 to run fan stages 452, 454 and 456 of low pressure compressor section 450. The rotation speed of fan stages 452, 454 and 456 may be controlled by an electronic controller. Thus, gravity-driven water flowing through water turbine 410 creates power in generator 416 that drives fan stages 452, 454 and 456 of low pressure compressor section 450. Naturally, in embodiments where some or all of the stages are not fan stages, the power may be used to drive another suitable mechanism for such stages, such as centrifugal or piston pumps or blowers.

In some embodiments, a gate mechanism 406 may be present to regulate the flow 402 of water that drives water turbine 410. Gate mechanism 406 is capable of restricting, or completely shutting off, the flow of water through compressor water channel 400. Gate mechanism 406 may be used to regulate the amount of electricity generated by generator 416 via speeding, slowing or stopping the rotation of water turbine 410. The operation of gate mechanism 406 can also be controlled by an electronic controller. However, rather than regulating the electricity, some embodiments may harness extra electricity for other purposes, such as providing some power to the dam.

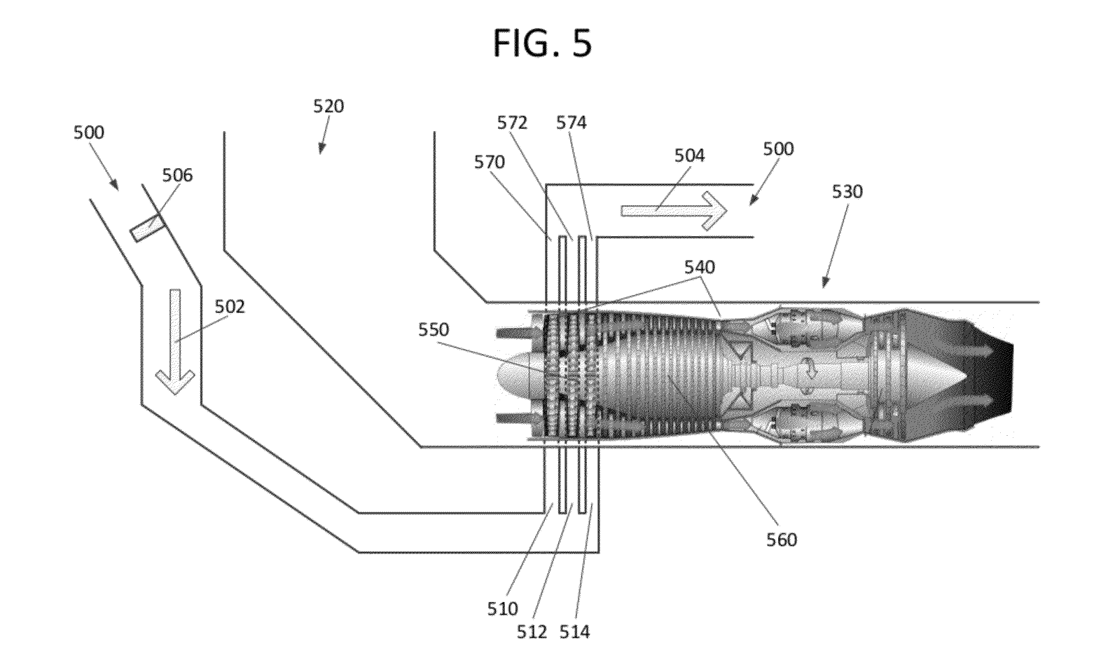

FIG. 5 is a side view of a system where a low pressure section 550 of a gas turbine 530 in a dam is powered by water running through external blades on the compressor stages, according to an embodiment of the present invention. In some embodiments, the system depicted in FIG. 5 may be present in the system depicted in FIG. 1. Gas turbine 530 has a compressor 540 for compressing air that enters through air intake 520. Compressor 540 has a low pressure section 550 and a high pressure section 560, each including multiple fan stages. In this embodiment, low pressure section 550 includes three fan stages.

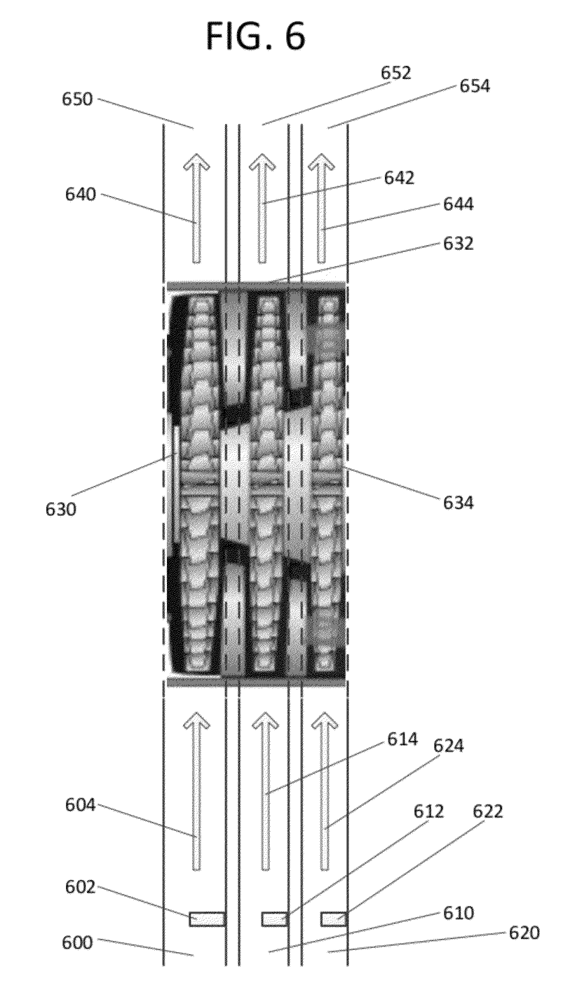

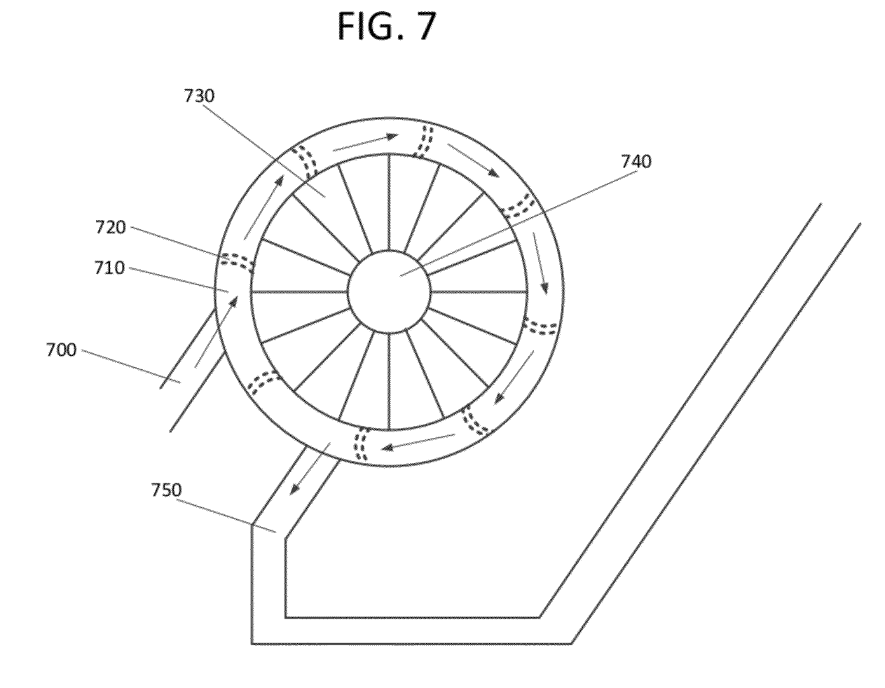

Water from a dam enters compressor water channel 500 and flows 502 towards entry inlets 510, 512 and 514, which compressor water channel 500 branches into. The water is driven by gravity due to head of the dam. The water enters entry inlets 510, 512 and 514 and drives the respective fans via external blades (not shown). This mechanism is shown in more detail in FIGS. 6 and 7. Gates (not shown) may be present for each of entry inlets 510, 512 and 514 to regulate the flow of water into each inlet.

The water pushes the external blades and causes each fan stage to rotate. Each fan may be closely joined to the next such that water is not able to flow into the fan stages. Or, the fans may have small gaps therebetween to allow water to enter low pressure section 550 of gas turbine 530 and increase the mass of the air flowing therethrough. A further option is to have small valves or gates on the outside of each fan that allows a desired amount of water to flow into low pressure section 550 of gas turbine 530, or restricts the flow thereof.

After passing through the fan stages of low pressure section 550, water flows through the respective exit outlets 570, 572 and 574, and then merges back into compressor water channel 500. The water then flows 504 further down compressor water channel 500. In some embodiments (not shown), at least part of the water may then be used for injection into warmer stages of compressor 540 and/or into, around, and/or inside gas turbine 530. In some embodiments, water may be misted into a flow of exhaust gases leaving gas turbine 530 to reduce noise.

In some embodiments, a gate mechanism 506 may be present to regulate the flow 502 of water in water channel 500. Gate mechanism 506 is capable of restricting, or completely shutting off, the flow of water through compressor water channel 500. This gate mechanism may be in addition to, or in lieu of, gate mechanisms within entry inlets 510, 512 and 514. Where entry inlets 510, 512 and 514 do not have water flow regulating mechanisms, the diameter of each entry inlet may be sized such that the desired amount of water feeds and spins the fan stages of low pressure section 550 at the desired speed. Further, each exit outlet may be designed so as to carry the appropriate flow of water away from the respective fan stage.

While the fan stages of low pressure compressor section 550 may spin at the same speed due to their connection to a common school in some embodiments, different relative fan speeds may be possible in some embodiments, particularly where fan stages do not share a spool. For instance, the diameter may be designed such that for three fan stages, the second fan stage spins 1.5 times as quickly as the first fan stage and the third fan stage spins twice as fast as the first fan stage. Naturally, the specific speeds would vary with the desired turbine performance and implementation.

FIG. 6 is a side view of the water feed mechanism for three fan stages 630, 632 and 634 of a compressor, according to an embodiment of the present invention. In some embodiments, the water feed mechanism may be present in the system of FIG. 5. Water may be provided to the water feed mechanism via a compressor water channel, for instance.

Water enters each of entry inlets 600, 610 and 620. Gate mechanisms 602, 612 and 622 meter respective water flows 604, 614 and 624 for entry inlets 600, 610 and 620, respectively. Water flows 604, 614 and 624 then enter each respective fan stage 630, 632 and 634, pushing external blades (not shown) on the fan stages that cause fan stages 630, 632 and 634 to rotate. After the water passes through fan stages 630, 632 and 634, respective water flows 634, 642 and 644 enter and flow through respective exit outlets 650, 652 and 654.

FIG. 7 is a front view of a compressor fan stage that is driven by water flowing through external blades, according to an embodiment of the present invention. In some embodiments, the compressor fan stage of FIG. 7 may be present in FIGS. 5 and/or 6.

Water flows through entry inlet 700 and into water conduit 710. There, the water contacts and rotates blades, such as blade 720. The compressor fan stage rotates about shaft 740, spinning compressor fan blades 730. The rotation of compressor fan blades 730 pressurizes air and pushes the air through the compressor. Once water has rotated around water conduit 710, the water exits water conduit 710 and flows into exit outlet 750. The design of the water inlet system and the number of blades engaged between entry inlet 700 and exit outlet 750 is a matter of design choice. In this embodiment, each fan stage has its own entry inlet, water conduit and exit outlet. However, in some embodiments, multiple fan stages may share a single water conduit, or all fan stages of a given compressor section may share a common water conduit. Further, the inner wall of a water conduit may serve as a mounting surface for the blades.

In the embodiments discussed in FIGS. 5-7, the externally-driven blades may improve efficiency over other configurations, such as an internal blade configuration. Also, the water flow in the water conduits acts as coolant for the gas turbine. Further, in some embodiments, the internal air blades are also “shrouded” (i.e., no significant gap between the blade tip of each fan blade to the outer casing). This may reduce air losses due to blow-by.

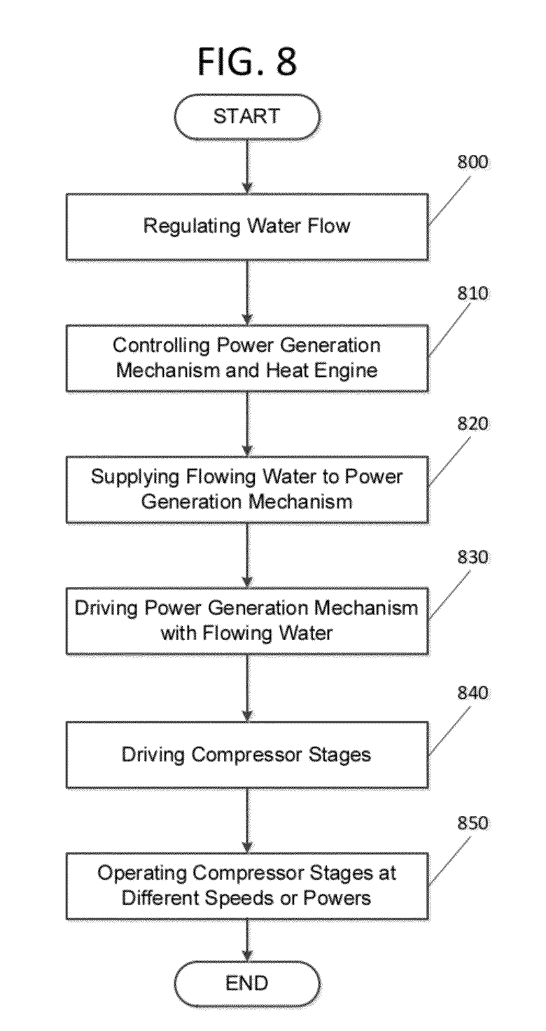

FIG. 8 illustrates a flow diagram of a method for powering one or more stages of a compressor, according to an embodiment of the present invention. The method begins by regulating water flow in a compressor water channel at 800. The water flow may be regulated by a gate mechanism, including any suitable water flow control mechanism such as a valve. The flowing water in the compressor water channel is driven at least in part by gravity due to head of the dam. The operation of a power generation mechanism and a heat engine are controlled at 810 via an electronic controller. The operation may be adjusted based on the desired power to be generated by the power generation mechanism and the desired operation of the heat engine.

Flowing water is supplied from a dam to the power generation mechanism via the compressor water channel at 820. The flowing water drives the power generation mechanism at 830. Power generated by the power generation mechanism is then used to drive one or more compressor stages of the heat engine at 840. If desirable for the operation of the heat engine, the one or more compressor stages may be operated at different speeds or powers at 850.

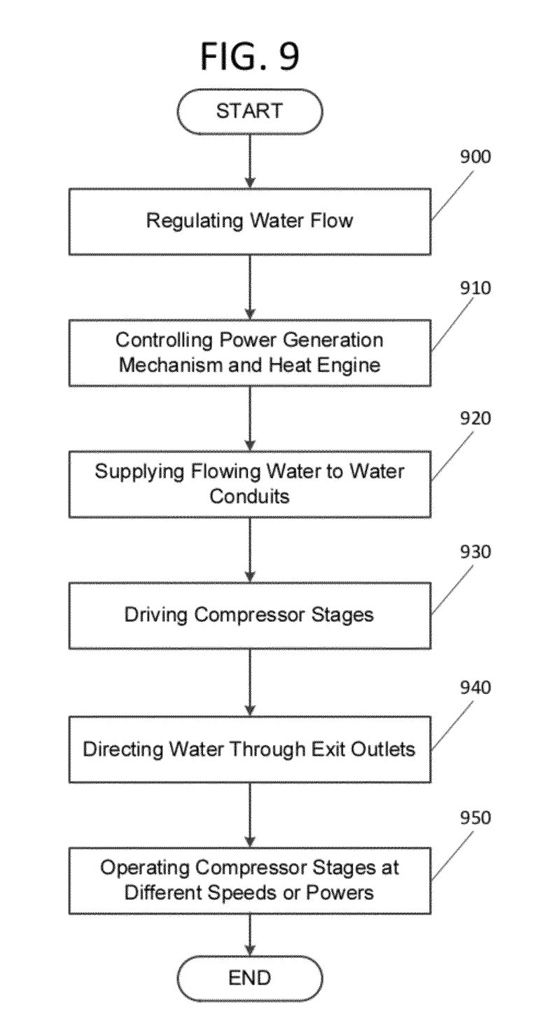

FIG. 9 illustrates a flow diagram of another method for powering the one or more stages of a compressor, according to an embodiment of the present invention. The method begins by regulating water flow in one or more entry inlets at 900. The water flow may be regulated by gate mechanisms, including any suitable water flow control mechanism such as a valve. The flowing water in one or more entry inlets is driven at least in part by gravity due to head of the dam. The operation of a power generation mechanism and a heat engine are controlled at 910 via an electronic controller. The operation may be adjusted based on the desired power to be generated by the power generation mechanism and the desired operation of the heat engine.

Water is supplied from the one or more entry inlets to one or more water conduits at 920. The water flowing through the one or more water conduits drives external blades of the one or more compressor stages at 930, causing the one or more compressor stages to rotate. Water is then directed out of the one or more water conduits through one or more exit outlets at 940. If desirable for the operation of the heat engine, the one or more compressor stages may be operated at different speeds or powers at 950.

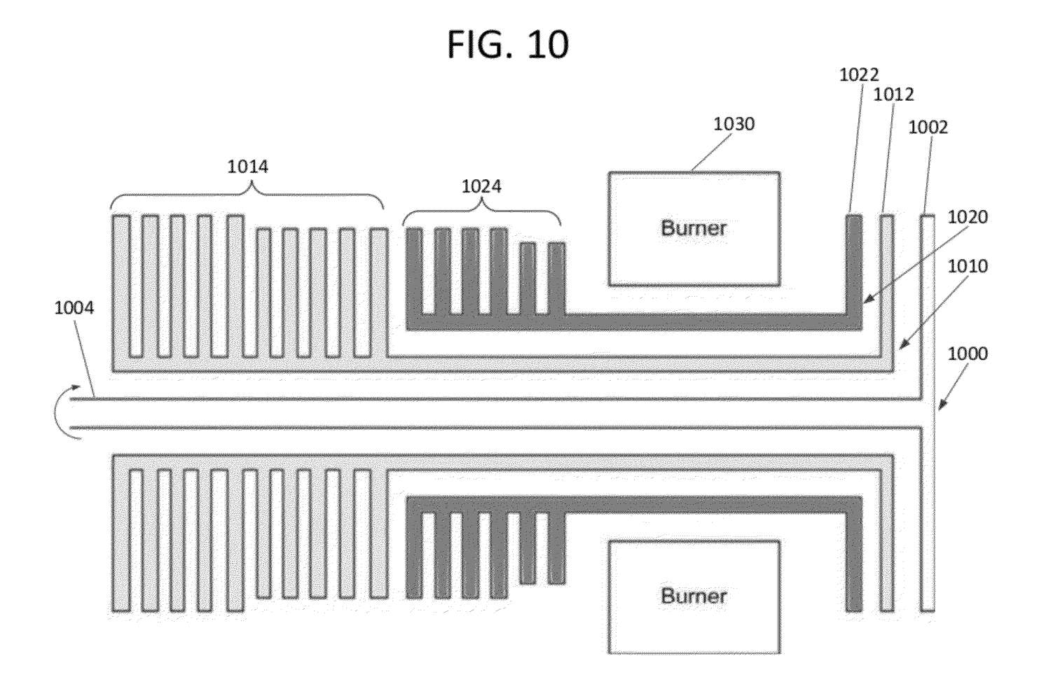

FIG. 10 is a side view of a gas turbine, according to an embodiment of the present invention. In some embodiments, the gas turbine of FIG. 10 may be present in one or more of FIGS. 1-5. In FIG. 10, the gas turbine has three spools—a turboshaft spool 1000, a low pressure spool 1010, and a high pressure spool 1020. While three spools are shown in this embodiment, more or fewer spools may be present, and the number of spools and compressor stages that are used is a matter of design choice.

Low pressure spool 1010 is nested within high pressure spool 1020, and turboshaft spool 1000 is nested within low pressure spool 1010. Further, the upper and lower portions of the spools depicted in this side view are all part of the same cylindrical spool. The gas turbine also has a cylindrical burner 1030. In some embodiments, rather than a single burner, multiple burners may be used. The gas turbine depicted in this embodiment is an aeroderivative gas turbine, but in some embodiments, non-aeroderivative gas turbines may be used. Aeroderivative gas turbines are based on aircraft engines.

Each spool has a respective turbine 1002, 1012 and 1022. Low pressure spool 1010 has a low pressure compressor section 1014 including a series of fan stages and high pressure spool 1020 has a high pressure compressor section 1024 that also includes a series of fan stages. Rotation of turbines 1012 and 1022 also causes respective compressor sections 1014 and 1024 to rotate due to sharing of a common spool.

Air is compressed by low pressure compressor section 1014 and high pressure compressor section 1024, and then passed through burner 1030. The air is mixed with fuel, which is then combusted, creating hot exhaust gases. The hot exhaust gases then flow through turbines 1002, 1012 and 1022, causing the turbines to rotate. Rotation of turbine 1002 rotates turboshaft spool 1000, which causes shaft 1004 to rotate. The rotation of shaft 1004 can be used to do work, such as drive a generator. The hot exhaust gases then exit the gas turbine via a nozzle (not shown).

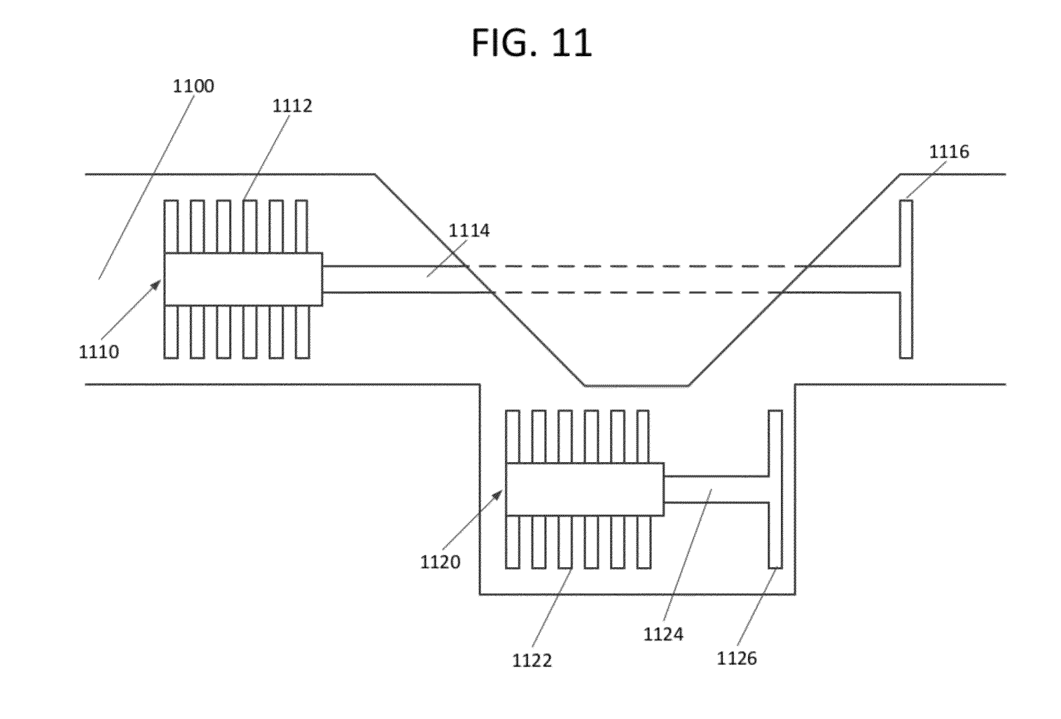

FIG. 11 is a side view of a section of a gas turbine with non-nesting spools, according to an embodiment of the present invention. In some embodiments, the gas turbine of FIG. 11 may be present in one or more of FIGS. 1-5. Air enters the gas turbine through air intake 1100. The gas turbine includes two non-nested spools, low pressure spool 1110 and high pressure spool 1120. Low pressure spool 1110 has a low pressure compressor 1112, a shaft 1114, and a turbine 1116. High pressure spool 1120 has a low pressure compressor 1122, a shaft 1124, and a turbine 1126. Unlike with FIG. 10, low pressure spool 1110 is not nested within high pressure spool 1120. While the drawing shows space between compressors 1112 and 1122 and the sides of the turbine, such space is not typically present in order to encourage air to flow through the compressors without a path around. Further, the number of spools and the location thereof, as well as which spool is actually driven, is a matter of design choice. Additionally, the spool that is being driven may not have a turbine, or at least have a turbine with a reduced size, power, and flow. Such a partial spool may thus be placed anywhere, which may improve packaging, flow, maintenance, etc.

Some embodiments of the present invention take advantage of dam head to supply flowing water that either directly or indirectly drives one or more stages of a compressor of a heat engine. The flowing water may either drive a power generation mechanism that drives the one or more compressor stages, or directly drive the one or more compressor stages via external blades on the compressor stages. In this manner, a virtually perpetual, and non-polluting, source of energy may be provided to power the one or more stages of the compressor, saving fuel and facilitating highly dispatchable power from the heat engine.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A system, comprising:
a power generation mechanism configured to be driven by flowing water;
a compressor water channel configured to supply flowing water from a dam to the power generation mechanism; and
a heat engine comprising a compressor with one or more compressor stages, wherein
the power generation mechanism is configured to drive the one or more compressor stages, and
the flowing water in the compressor water channel is driven at least in part by gravity due to head of the dam.

2. The system of claim 1, wherein the power generation mechanism comprises a direct mechanical water drive, a direct electrical water drive, or a combination of a water turbine and a generator.

3. The system of claim 1, further comprising:
a gate mechanism operably connected to the compressor water channel, wherein
the gate mechanism is configured to regulate the flow of water in the compressor water channel.

4. The system of claim 1, wherein
the power generation mechanism comprises a direct mechanical water drive,
a power transfer mechanism operably connects the direct mechanical water drive to the one or more compressor stages,
the direct mechanical water drive is configured to be rotated by the flowing water, and
the rotation of the direct mechanical water drive powers the power transfer mechanism, the power transfer mechanism driving the one or more compressor stages.

5. The system of claim 1, wherein
the power generation mechanism comprises a direct electrical water drive,
the direct electrical water drive is configured to be rotated by the flowing water and to generate electricity during rotation,
the direct electrical water drive is configured to supply electricity to the heat engine via a power cable, and
the heat engine is configured to use the supplied electricity to drive the one or more compressor stages.

6. The system of claim 1, wherein
the power generation mechanism comprises a combination of a water turbine and a generator that are operably connected via a shaft,
the flowing water rotates the water turbine, which rotates the shaft and generates power in the generator,
the generator is configured to supply electricity to the heat engine via a power cable, and
the heat engine is configured to use the supplied electricity to drive the one or more compressor stages.

7. The system of claim 1, further comprising:
an electronic controller configured to control operation of the power generation mechanism and the heat engine.

8. The system of claim 1, wherein the one or more compressor stages are configured to be operated at different speeds or powers.

9. An apparatus, comprising:
one or more compressor stages of a heat engine having one or more external blades;
one or more water conduits surrounding the one or more compressor stages; and
one or more entry inlets configured to supply flowing water from a dam to the one or more water conduits, wherein
the flowing water drives the external blades of the one or more compressor stages, causing the one or more compressor stages to rotate, and
the flowing water is driven at least in part by gravity due to head of the dam.

10. The apparatus of claim 9, wherein at least one of the one or more entry inlets comprises a gate mechanism configured to meter the flow of water in the respective entry inlet.

11. The apparatus of claim 9, further comprising:
an electronic controller configured to control operation of the heat engine.

12. The apparatus of claim 9, further comprising:
one or more exit outlets configured to channel water that has passed through the water conduits away from the heat engine.

13. The apparatus of claim 8, wherein the one or more compressor stages are configured to be operated at different speeds or powers.

14. A method, comprising:
supplying flowing water from a dam to a power generation mechanism via a compressor water channel;
driving the power generation mechanism using the flowing water to generate power; and
driving one or more compressor stages of a heat engine using power generated by the power generation mechanism, wherein
the flowing water in the compressor water channel is driven at least in part by gravity due to head of the dam.

15. The method of claim 14, wherein the power generation mechanism comprises a direct mechanical water drive, a direct electrical water drive, or a combination of a water turbine and a generator.

16. The method of claim 14, further comprising:
regulating the flow of water in the compressor water channel via a gate mechanism.

17. The method of claim 14, further comprising:
controlling operation of the power generation mechanism and the heat engine via an electronic controller.

18. The method of claim 14, further comprising:
operating the one or more compressor stages at different speeds or powers using the electronic controller.

19. The system of claim 1, wherein the one or more compressor stages are operably connected to a spool, the spool is operably connected to a turbine, and rotation of the turbine rotates both the respective spool and the one or more compressor stages.
